(19) United States
(12) Patent Application Publication
(10) Pub. No.: US 2023/0334574 A1
(43) Pub. Date: Oct. 19, 2023

(54) SYSTEM METHODOLOGY FOR AUTONOMOUS MONETARY AND COMMERCE GENERATION, REGENERATION, DISTRIBUTION, AND REDISTRIBUTION

(71) Applicant: Anthony Christopher Saint Michael, Milford, OH (US)

(72) Inventor: Anthony Christopher Saint Michael, Milford, OH (US)

(21) Appl. No.: 17/720,105

(22) Filed: Apr. 13, 2022

(51) Int. Cl. G06Q 40/06; G06Q 20/06; G06Q 30/02

(52) U.S. Cl. CPC G06Q 40/06; G06Q 20/065; G06Q 30/02; G06Q 50/01

(57) ABSTRACT

A comprehensive Socio-Financial, Socio-Economic, Socio-Commerce, distribution and re-distribution system comprised of various technologies adapted to achieve an (Eco) System Network engineered specifically to generate “Autonomous Money” in addition to varied forms of Finance and Commerce propagation. The generation and propagation are accomplished through a dynamic exchange of money, goods, or services, through a unique methodology, accomplished through a series of fully and/or semi-automated, synchronous, homogenous internet interactions and transactions. The purposeful outcome in one sense is to provide a comprehensive, realistic and reliable residual income type system that is organic and possible-of-attainment by the greater masses of humanity. In another aspect, the system is capable of producing considerable worldwide economic stimulation as well as realistically enabling a Universal Basic Income (UBI) without burdensome taxation. However, because this System possesses a multifaceted approach to Commerce, as well as the generation of wealth, the UBI humanitarian aspect is but one of various applications.

### TECHNICAL FIELD

This invention relates to a comprehensive financial system consisting of various technologies adapted to achieve a Universal Basic Income (Eco) System, or Residual Income type System, engineered specifically to produce “Autonomous Money”, Commerce, and Services proliferation through a dynamic exchange of money, goods, or services, achieved through an incentivized reciprocating gifting and donation system utilizing various types of methodologies and internet platforms.

### BACKGROUND OF THE INVENTION

It can be said that humanity is its own greatest resource, and the technologies that have been developed have greatly enhanced and elevated the lifestyles of many. However, the vast majority of humanity nevertheless continues to labor under monetary want and deprivation, notwithstanding all of the modern technologies meant to supply mankind with sufficient to abundant money, goods, and services.

The primary technology system concerned here is monetary generation through crowdfunding and residual income type systems. These are coincidentally comprised of finance, commerce, and communication, operating primarily on or through internet platforms; systems which are typically well known and generally accessible to the vast majority of humankind. However, the utilization of these systems for the monetary benefit of the vast majority of humankind has been lacking in efficacy for any number of reasons, not the least of which concerns the lacking of technical prowess or any varied business acumen or ability, as well as the shortcomings of the systems themselves. The ability of people to earn or generate money, therefore, becomes societally lopsided, leaving the average person, the elderly, disabled, and others, without the talent or any varied personal means to easily and readily earn or generate money utilizing crowdfunding or residual income type systems. This inability furthermore often extends to even ordinary employment means of generating sufficient money for individuals to adequately support themselves in the near-term, or moreover, to provide for their future and retirement needs.

For the average person faced with erratic economic conditions, declining wages, inflation, reduced or non-existent retirements or healthcare benefits, rising rates, insufficient education, mental or physical health issues, and a host of other inhibiting factors, monetary generation or acquisition is the number one need and concern.

Loans can be difficult to come by, and qualifying for them can be prohibitive for those with a medium to low credit score. This, along with inflation and high-interest rates can prohibit the purchase of cars and homes and even lesser modern necessities which are the mainstay of life. Even employability can be compromised when employers judge employees by their credit standing. The savings and loan area of finance is crucial to the livelihood and well-being of individuals and families. A need, therefore exists for a more equitable, useful, and attainable loan system.

Government assistance and benefit programs are dependent upon a strong economy and a strong consequent tax base. Government retirement programs are equally likewise dependent. Corporations and businesses rely on the strength of economic activity to generate sufficient revenue to provide their employees with sufficient wages, retirements, and healthcare. Therefore, economic systems are key to the health of individuals, societies, their governing bodies, and businesses, and a need exists to support and strengthen these systems.

Monetary policies of governments, banking, lending, and financial institutions, along with monetary systems including fiat currencies, cryptocurrencies, Decentralized Finance (DeFi), stock and bond markets, and financial and monetary instruments in general are systems largely outside the deeper or operative understanding of the average person, but within their general knowledge. These systems operate often to the exclusion of the vast masses if not their detriment, generally benefiting and enriching only those who are adept at them. The greater masses of humanity therefore are unable to utilize these systems to readily generate wealth for themselves. Additionally, these systems tend to be complex, manipulated, exclusive, and sometimes unreliable, resulting in uncertainty and subsequently unusable for even the above-average person to benefit from them, and certainly not without any significant social standing, background, education or effort. A need therefore exists to provide a readily usable, attainable, and fully inclusive monetary generation and financial system for the vast masses of humanity.

A need therefore exists to provide for a crowdfunding type donation or gifting system which works all of the time for all of the participants involved, as well as a Residual Income System or Social Network Marketing system which does not require the participants to unreasonably self-educate, other-educate, sell any product, or recruit others.

A need also exists to provide a more stable, globally and societally beneficial, useful and workable Universal Basic Income (UBI) or residual income type system; a combined monetary, finance, commerce, and economic system that can effectively generate, re-generate, distribute and re-distribute money, goods, and services, easily and attainably by, and to the benefit of, the vast masses of humanity, from the young to the elderly, from cradle to grave; a system which additionally supports businesses, governments and stimulates world economies; a system which can be superimposed upon existing world and existing technology systems wholistically and organically, with the least amount of disruption and the maximum amount of impact.

### SUMMARY

In one embodiment of the invention, the system provides a more useful and productive way for users to give and receive money relating to crowdfunding platforms. it is to the provision of such that the present invention is primarily directed.

Furthermore, since the aggregate (Eco) System requires a means of generation of wealth, that wealth being (initially) crowdfunding related, and otherwise Commerce (“Module”) related, it is to the provision of such that the present invention is also primarily directed.

Additionally, since the primary drawback to most all proposed Universal Basic Income (UBI) Systems is due to the main if not sole source of monetary capitalization being through taxation, the invention intends an entirely novel and unique methodology of monetarily capitalizing a Universal Basic Income; as well as any other Residual Income type system.

The invention ultimately and ingeniously provides a unique and entirely workable mechanism for a non-tax based Universal Basic Income (UBI) System, as well as an Economic Stimulating System, due to its Monetary and Commerce Generation, Re-generation, Distribution, and Re-distribution mechanism(s) achieved through the System’s Reciprocating Crowdfunding and Multi-Module Matrixed aspects.

In another embodiment of the present invention, the system and method are comprised of separate, several, and combined business and financial models relating to various types of Social and Retail Commerce and monetized reciprocity platforms, creating a self-contained, self-regulating, self-perpetuating, self-supporting, self-sustaining (Eco) System.

Additionally, the invention is comprised of a system and method of synchronistic monetary generation, transaction, banking, and depository savings model and platforms, some of which involve DeFi, cryptocurrency, smart contracts, blockchain, and stablecoins.

Furthermore, the shortcomings of DeFi and public cryptocurrencies produce major drawbacks from its usage as a mainstream financial vehicle in a traditional goods and services commerce sense, as well as a reliably stable “currency”. Since its usage is predominant in the (Eco) System described, it is to the provision of such that the present invention is primarily directed.

Additionally, since the (Eco) System utilizes a means of banking of wealth as relates to credit, debit, and loans, in addition to the storage of wealth, that wealth being DeFi and cryptocurrency related, or otherwise, it is to the provision of such that the present invention is coincidently primarily directed.

In another aspect, the system utilizes the novel reciprocating methods of Crowdfunding to advantage the (Eco) System as well as [outside] Multi-level and Network Marketing systems, by providing “Auto-Sponsoring” and “Coding” protocols of the recruited to the recruiter or the “initiator” to the “sponsored”. This methodology is a new and improved system for hyper-accelerated recruiting, raising money, and producing commerce transactions.

One major drawback to traditional Network Marketing is the reliance on independent sales or marketing representatives (IMRs) to sell products and recruit others to become independent sales or marketing representatives. Many people find this aspect of Network Marketing unpleasant and awkward. This is a substantial problem, slowing the growth of the Network Marketing company. Another drawback to traditional Network Marketing is that it is totally dependent on distributor (IMR) performance.

Accordingly, it can be seen that a need yet remains for a Network Marketing arrangement that does not require the IMR to personally try to sell other people on the idea of becoming IMRs themselves. A need also exists for a Network Marketing approach that is not totally dependent on the performance of IMRs. It is to the provision of such that the present invention is secondarily directed.

In another aspect, the system utilizes methods of Multi-level Marketing monetary remuneration systems and algorithms to advantage Crowdfunding, Network Marketing, and the innovative (Eco) System.

In another aspect, the system utilizes both an App and dual aspect product “Mall”, with one aspect of the Mall being such as Amazon, Walmart, and various other commercial retail companies, or an entirely (Eco) System supplied aspect, without any outsider companies involved. Further, both aspects also concern services as well as goods.

In another aspect, the system uses an internet-based method for users to communicate within the system, with or without “coding” and “achievement qualifications”, as well as connects users with other users and professional and/or product-based services based on the users’ activities and industries.

In yet another aspect, the system utilizes Cryptocurrency and Blockchain technologies to enhance and/or provide retirement savings through an Incentivized Savings Depository that generates interest in the form of accumulating cryptocurrency cost and value. The system is also capable of providing users with secured loans based on their “savings” level for varied internal and external investment business and personal endeavors such as home mortgages.

In another aspect, the system validates users and varied business models and Module(s) with certain criteria to ensure the system’s integrity and trustworthiness in whole or in part.

In yet another aspect, the system uses a platform and App to facilitate all of the foregoing, which additionally provides a comprehensive information database relating to all the business model systems.

This invention seeks to overcome the deficiencies in all of the above mentioned Crowdfunding, Multi-level or Network Marketing, Cryptocurrency, and unincentivized Internet-based Information Sharing and Communication systems by taking the best of every system and acting upon it by modification, and/or utilizing it separately, severally, and/or multifariously in a hybrid manner to achieve the most optimum results possible from each business model system to advantage every particular and varied combination of model(s). The end result delivers a remarkable paradigm shift to the above industries and previous largely stand-alone business models.

### BRIEF DESCRIPTION OF THE DRAWING FIGURES

FIG. 1 is a block diagram flow chart depicting a Modular, Multiple Income Stream model of an Internet-based monetary and commerce generation, distribution and redistribution system according to a combined entirety form of the invention.

FIG. 2 is a functional block diagram flowchart of the FIG. 1 arrangement, illustrating the steps of monetary generation, distribution, and redistribution, along with finance management of same.

FIG. 3A is a functional block diagram of an Internet-based Reciprocating Crowdfunding arrangement in a more particular form of the invention that illustrates one particular methodology to achieve monetary generation and distribution for participants, achieved through a 2x5 matrix.

FIG. 3B is a flow chart diagram of the Reciprocating Crowdfunding arrangement as shown in FIG. 3A that more fully illustrates the methodology.

FIGS. s 4A and 4B are functional block diagrams of an Internet-based Reciprocating Crowdfunding arrangement in a more particular form of the invention, illustrating the unique “Auto Sponsoring” and “Coding” methodology.

FIGS. 5A and 5B are functional block diagrams of an Internet-based Socio-Commerce arrangement in a more particular form of the invention, illustrating the unique “Auto Entry” and “Auto-Re-Entry” methodology.

FIG. 6A is a functional block diagram of an Internet-based Socio-Commerce arrangement in a more particular form of the invention, illustrating the unique pay-out or monetary distribution methodology, specifically relating to the Vault Depository.

FIG. 6B is a functional block diagram of an Internet-based Socio-Commerce arrangement in a more particular form of the invention, illustrating the unique pay-out or monetary distribution throughout the entire System methodology.

### DETAILED DESCRIPTION OF THE PREFERRED EMBODIMENTS

The present invention sophisticatedly solves what has been long-standing problems compromising public cryptocurrency usage and stability; shortcomings with Crowdfunding; problems with financing Retirement and Insurance (of all types); problems with Social Commerce; as well as issues holding back Network Marketing by intelligently marrying some elements used in traditional Network or Multi-level Marketing with other technologies, such as Cryptocurrency and Crowdfunding, with Crowdfunding innovatively modified to be “reciprocating”, “recruiting”, and “coding”, all contained within a specialized (Eco) System to support the separate, several, and amalgamated whole of processes to achieve a balance and superior operational performance of each system individually and corporately.

In addition, the present invention also significantly solves what has been a longstanding problem with Civil and Government proposed Universal Basic Income (UBI) systems.

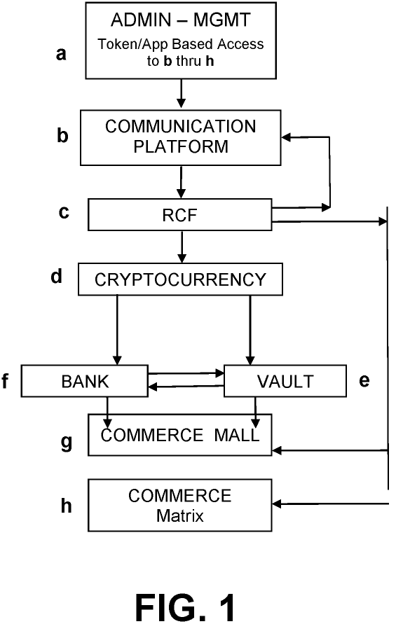

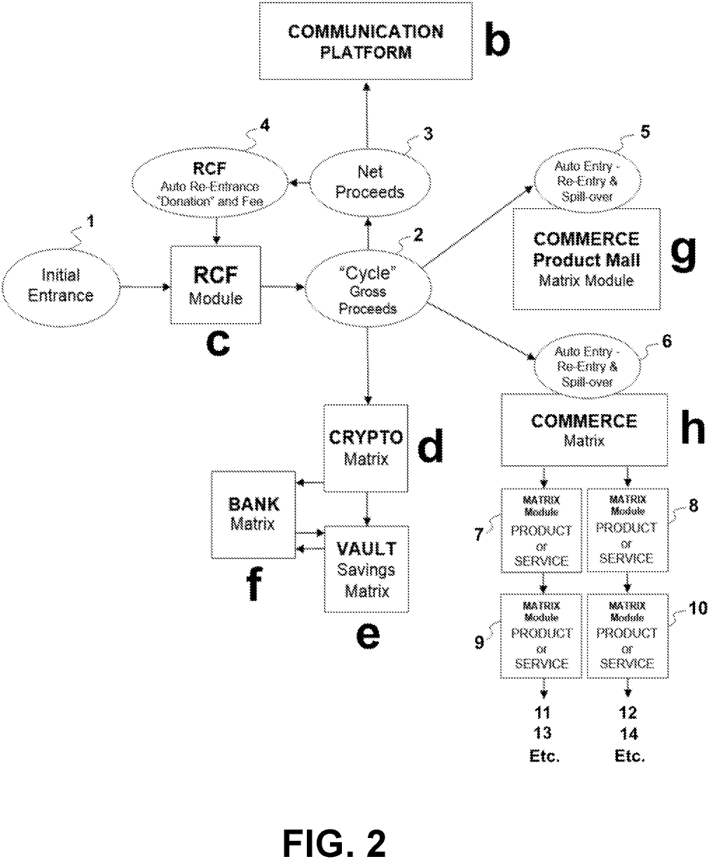

Firstly, this sophisticated solution is best understood first by reference to FIG. 1 and FIG. 2, which gives a good visual overview of the modular nature of the invention and then by reference to a narrative description. Accordingly, what follows is an overview of the figures and then a narrative of the methodology.

### OVERVIEW OF FIG. 1 AND FIG. 2

FIG. 1 and FIG. 2 are block diagram flowcharts illustrating a Multiple Income Stream methodology which demonstrates the potential progression or flow of participants from one aspect of a monetary generating mechanism into another. The following is a brief description of the several platforms:

FIG. 1, a, is an intersystem Administration and Management platform module that provides access to and control of the various other system modules.

FIG. 1, b, is an intersystem social media type communication module.

FIG. 1, c, is a Reciprocating Crowdfunding module.

FIG. 1, d, is an intersystem Blockchain, Cryptocurrency module.

FIG. 1, e, is a module utilized for financial transaction and monetary Savings purposes.

FIG. 1, f, is an intersystem module utilized for financial transaction and Banking purposes to compliment and better enable FIG. 1, e, functionality specifically, and compliment the entirety of the invention wholistically.

FIG. 1, g, is an intersystem module utilized for external Retail Commerce and Services transactional purposes.

FIG. 1, h, is an intersystem module utilized for Retail Commerce and Services transactional purposes which comprises and utilizes a Matrix monetary distribution and re-distribution system.

### Step 1: Entering Into the Reciprocating Crowdfunding (“RCF”) Platform System Initiating

FIG. 2, items 1, c, 2, 3, and 4, illustrate a novel form of Crowdfunding which is coincidently reciprocating, meaning participants share in both “donating” and being “donated to” through the known monetary mechanism of Crowdfunding, which in this case is modified to be reciprocating through a known 2x5 matrix methodology utilized in Multi-level and Social Network Marketing. In this innovative model, the donator(s) or giver(s) alternately become the donatee(s) or recipient(s), while the donatee(s) alternately become the donator(s), all taking place concurrently and synchronously. This provides exceptional incentive for individuals to “donate” or “gift”, which is an incentive that is lacking in typical Crowdfunding and holds it back. The donations in this case are monetary, but can also be goods and services, as shown in FIG. 2, item h, 7 thru 14.

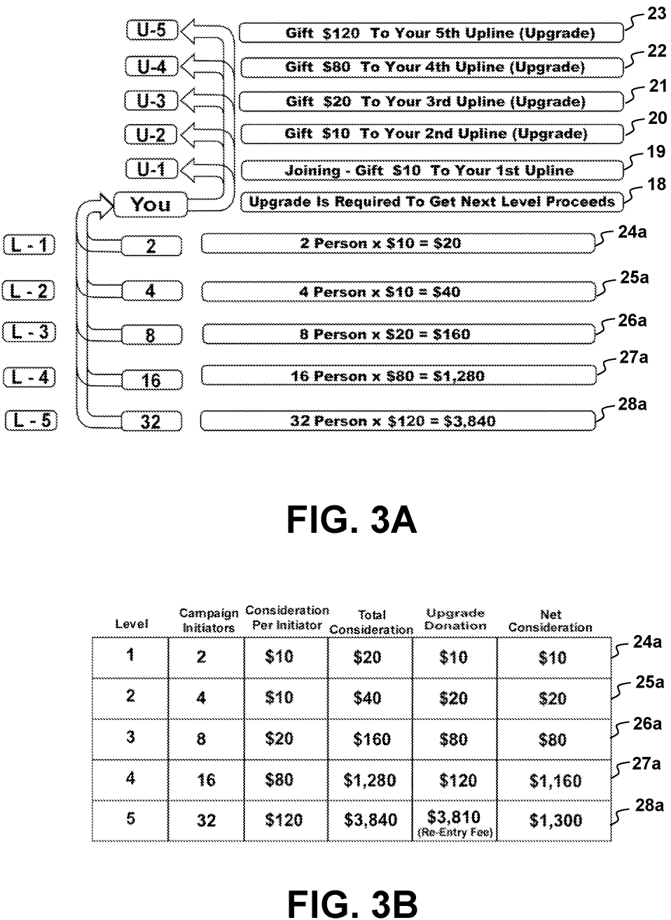

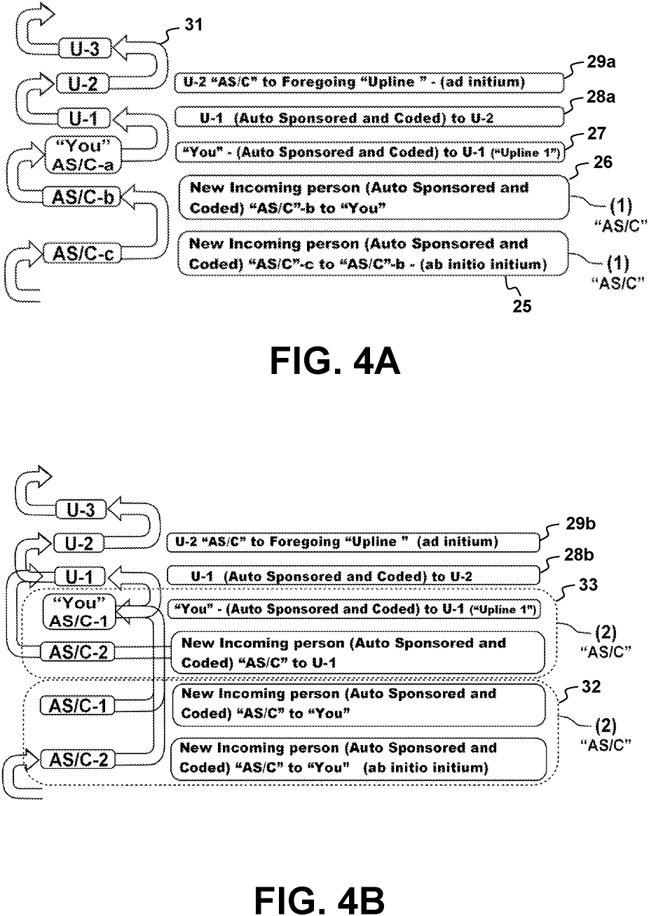

This incentivized sharing is accomplished when an individual, “You”, (FIG. 3A) 19, (FIG. 4A) 27, (FIG. 4B) 33, qualifies themselves to participate in the RCF by providing personal information such as banking, email address, etc., in known manner, and typical to any Crowdfunding platform. The individual, “You”, then “donates” a specified amount of money, in this case, a “joining gift” of $10 into the RCF system, which is automatically “donated” by the automated system to the person who directly preceded “You” into the system, i.e., “U-1” (FIG. 3A) 19a, (FIG. 4A) 28a, (FIG. 4B) 28b. The person following “You” into the RCF System likewise qualifies themselves and “donates” $10, with all subsequent individuals entering into the RCF system doing the exact same. This produces a single line of individuals processing through the RCF System, as clearly shown in FIGS. s 3A and 3B.

Additionally, after completing a FIG. 2, item 2 “cycle”, as detailed in FIGS. s 3A and 3B, through the RCF System and exiting it, this single line of individuals may automatically re-enter the RCF System (FIG. 2), item 4, thereby enabling the System to self-perpetuate, indefinitely, adding a systemically unique feature to the RCF System individually and the (Eco) System as an operational whole as further described. The reasons for re-entrance are further described herein, but the primary reason is for a participant to attain more money, goods or services, as well as sustain and substantiate the System separately and as an (Eco) System operational whole as will be shown.

### Step 2: Auto Sponsoring and Coding

The system can also provide “Coding” of Invitation Recipient (IR) recruited individuals shown in FIGS. s 4A and 4B to provide a permanent connection of the recruited IR to the recruiting IR, for the benefit of both. FIG. 4A relates specifically to a Single Pass-through - Single Sponsoring or Coding, while FIG. 4B relates specifically to a Single Pass-through - Double Sponsoring or Coding arrangement. The purpose of Coding would ensure that the Invitation Provider (IP) and IR are organically and automatically connected throughout the entire (Eco) System. This would occur when they become auto-enrolled into any given subsequent Module, such as from FIG. 1, c, into FIG. 1, d thru h, for example, and so on throughout the (Eco) System.

The automated RCF system then automatically Codes or permanently affixes “You” to the upline “U-1” individual. The “U-1” individual then becomes the (potential) “Sponsor” of the “You” individual for the subsequent progression from the FIG. 1, c, RCF platform into participating in any one or number of the subsequent Modules shown in FIG. 1, as e, f, g, or h.

The ideal and preferred (Eco) system methodology is as shown in, but not limited to, FIGS. s 1 and 2. A configuration of two or more Modules, beginning with the RCF Module and “feeding into” subsequent Modules which are Commerce and Service related is useful for the longevity of monetary distribution or residual income type pay-out and the overall health and ultimate purpose of the (Eco) system.

### Step 3: Personal Sponsoring and Coding

Personal, direct sponsoring, and thus specific coding of recruited individuals can effectively be accomplished in the FIG. 1, c, RCF Module. Direct sponsoring could additionally be accomplished in a Binary or Matrix Module first, which again would have the lowest cost entry point and a one-time initial out-of-pocket expense. The recruited person thus coded to the Direct Sponsor would enter into the FIG. 1, c, RCF Module, but would not be codeable to the previous “You” entrant. To overcome this deficiency, the system would automatically provide coding of the next available and non-coded individual entering for their first or initial re-entry time into the RCF Module to the “You” individual. There are many other methods to handle this difficulty, potential “cross-line” multi-coding issues, and even multiple coding’s can be accomplished to multiple individuals without harm to Direct Sponsor downlines in non-RCF Modules, and if utilized in a Network Marketing manner or with outside Network Marketing companies.

### Step 4: Automatic Sequential Module Entrance

The initial person “You”, FIG. 3A, 18, starts their individual Crowdfunding process by making a monetary “donation” into the system FIG. 2, item 1, which is “donated” or “gifted” to the person who directly preceded “You” into the system FIG. 3A, item 19. The platform programming automatically accounts for and provides for this, as well as providing for the “coding” of “You” to the person who directly preceded “You” into the system (“U-1”). “You” may then optionally send “invitations” to others via the Crowdfunding platform, other online means, or other means. When the Invitation Recipients (IRs) or others subsequently sign up and donate to “You”, “You” receive two of the donations, FIGS. s 3A and 3B, item 24a. -Assuming the System, or “You”, secures other individual(s) to sign-up, and the System or other individual(s) likewise obtain sign-ups, or Word Of Mouth (WOM) otherwise populates the system, the process systematically continues in a relatively linear and exponential fashion. The system can continue in a relatively indefinite and circuitous fashion if a re-entry element is added to the equation, FIG. 2, items 5, 10, 12. It can also have a re-entry limit as proposed in the FIGS. s 3A and 3B schematic, proposing that the IR must start all over again after L-5 (Level 5) through any varied re-entry process.

Applying a Multi-level Marketing methodology to the above equation seamlessly enables a growing network of individuals to share in the Crowdfunding experience or monetary enrichment via known Multi-level methods such as the preferred method of a Matrix, or a Binary, Trinary or other known MLM pay-out methodology. Other known Multi-level compensation methods are Unilevel, Forced Matrix, and Breakaway Plans that can be utilized in this Incentivized Sharing Crowdfunding Platform. However, the preferred method for the RCF Module is the simple linear method resulting in a 2x4 or 2x5 (or higher) level matrix as shown in FIGS. s 3A and 3B.

The Crowdfunding system just described is a significant improvement over the general Crowdfunding models that benefit only the Campaign starter (IP) and are therefore non-monetarily incentivized for the giver. The exception is with rewards, debt, and equity types of crowdfunding. However, these are costly and burdensome campaigns to employ for generating financing, and limited to the specific equity purpose for which the campaign is initiated, although they can employ the RCF model to enhance their performance.

The uniquely Reciprocating Crowdfunding system just described can operate as a stand-alone model, sufficient unto itself. However, as shown in the FIG. 2 flowchart, the Crowdfunding model can assist in populating and financing various additional direct sales MLM entities, in series as shown, or individually, skipping over any given individual or several Figure(s), although any and all generally leading up to the VAULT “Depository” in FIG. 1, item e, which itself can function as a stand-alone Crowdfunding entity, fueled or nourished by employing the Crowdfunding system just described as its underpinning, or any MLM Multi-level or Unilevel type system, and need not be included in the modular system shown in FIG. 1 in order to be a viable functioning model system platform entirely unto itself.

### Step 5: Auto-Enrollment into Subsequent Modules

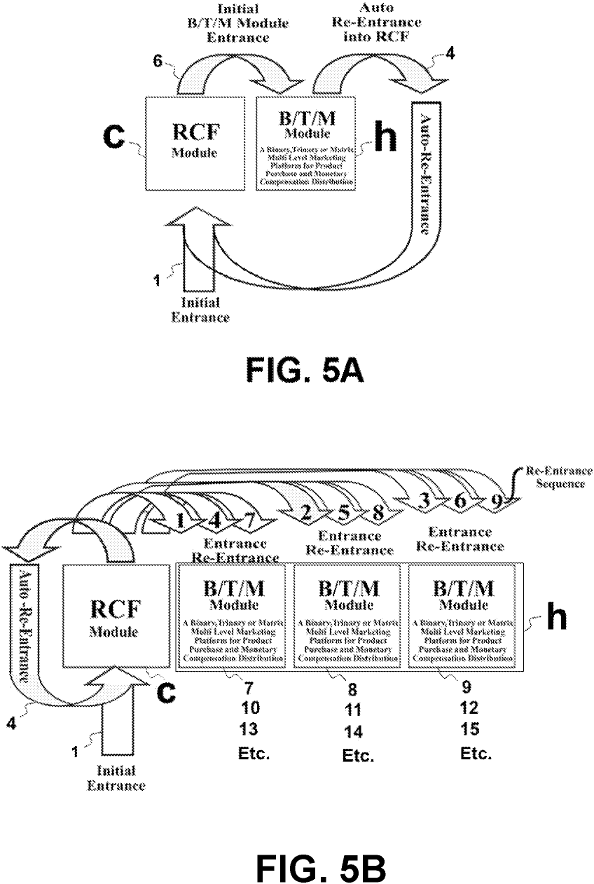

When the automated consecutive progression mechanism is used, as shown in FIGS. 5A and 5B the participants in each Module are automatically enrolled into a subsequent Module when they qualify. Qualification is based on their previous Module reciprocating donation achievement level or subsequent Module earnings to enable them to finance the purchases required in any given Module with the proceeds of the previous Module, thereby making their purchased products appear free and lessens the burden of out-of-pocket expenses, which in turn addresses the typical, significant, and overwhelming Multi-level Marketing challenge of recruitment and retention.

FIG. 5A shows the two primary, most necessary, and most integral Modules of the System, the RCF Module (item c) and the Crypto Currency Module (item d). The Auto-Entry and Auto-Re-Entry sequencing is shown in general as “Re-Entrance Sequence” numbers 1 thru 9. Both Auto-Entry and Auto-Re-Entry are dependent upon the Auto-Sponsoring mechanism of the RCF Module, as described further on.

This methodology uniquely frees the participants from ever having to expend any personal finances other than the initial $10 donation example gifted into the RCF system. It also frees the participants from having to directly sponsor anyone because the RCF system elegantly, sophisticatedly, and innovatively does that for them. This single innovation resolves the major problem the “average person” experiences when joining a Multi-level Marketing company, which is recruiting and sales, both of which aspects generally require a significant amount of personal investment of time and training, which most people are not willing, or free to do, or interested in, or capable of doing because they simply don’t possess the talent, gift, or facility; traits which can be considered the hallmark of the “average person”. This single issue has plagued and limited the Social Network Marketing and MLM industry to the point of essentially sluggish to stagnated growth. The RCF methodology, for the first time in history, opens the door wide to the masses of the “average person” and provides them every means to be treated fairly, equitably, and inclusively. It is capable of virtually elevating even the poorest person, the least talented person, the least intelligent person, physically compromised persons, virtually effortlessly. Uniquely, through the methodology described, the system effectively becomes self-propagating.

By virtue of the participant being able to innovatively re-enter and re-cycle through the RCF system, system integrity, longevity and sustainability are assured. This single feature alone provides remarkable incentive for retention, interest, and particular allure.

For participation in the subsequent “Single Purchase” matrix or binary (a single direct out-of-pocket purchase coming either from the individual directly or through the automated RCF System process), FIG. 2, items 1, c, 2, 3, 4, and FIG. 3A, items 19, 20, 21, 22, 23, the participant was automatically provided with one or two Auto-Sponsored individuals who subsequently followed after them into the RCF system, thereby qualifying them for earnings as shown in FIG. 4A as (1)″AS/C″, (Auto-Sponsored / Coded) and FIG. 4B as (2)″AS/C″, and their participation in any other given Module such as shown in FIG. 2, items 7 thru 14, is paid for by a certain percentage of proceeds from the previous RCF Module. This cohesive and organic flow from one Module into another assures the highest monetary and sales return for participating companies which utilize the (Eco) System and the individuals who participate in it.

When the RCF is utilized in conjunction with this holistic and synergistic modular system configuration, the RCF “jump-starts” individual participation into the Multi-level Marketing industry, painlessly, seamlessly, almost effortlessly. The potential to increase the industry size is virtually incalculable, but most certainly the increase could be by many multiples.

The RCF Module, as an initiating system “jump-starts”, and further provides a means for making the entire (Eco) System capable of “going viral”, (i.e., one form of “hyper-accelerated”) due to the low-cost admission, the ease of use, and the fully automated Sponsoring, Coding, and Auto-enrollment into other Modules. As such, the RCF Module is the “heart” of the entire system.

In the “Flow Chart” (system) shown, the Crowdfunding aspect or Module and each subsequent aspect or Module can be set up to automatically enroll an IP into the next subsequent Module of the system, as indicated by the arrow of (FIG. 1) c, to b, d, e, f, g, and h. However, the Modules most specific to the system and Invention are FIG. 1, c, d, e, and h, which can operate independently of all other Modules, and even independent in and of themselves, though generally the (Eco) System is designed for these three specific Modules, (FIG. 2) c, d, and e, to operate cooperatively and associatively together, the one Module “feeding into” other subsequent Module(s).

By automatic enrollment, the system becomes further self-propagating, further reducing or eliminating the need for “recruiting” by Sponsors to more costly, more involved, or more advanced Modules of the system. This gentle and organic system of automatic enrollment from one platform Module to the next produces a gradual and graduated involvement, reducing the need to overload participants with complicated training and/or overburdening the MLM IR recruiting Distributors.

### “Sponsoring”, “Coding”, “Qualifying”

In the Crowdfunding Module, single or multiple levels can be employed to enable higher levels of monetary achievement for those interested or so disposed, as shown in FIGS. ′s. 3A and 3B, and otherwise anticipated. This can also be achieved by automatic enrollment and would simply involve a set amount of monetary deduction from the participant at a certain point and level of achievement. This higher reward of donation and potential return would further incentivize involvement in and Word-Of-Mouth (WOM) promotion of the RCF system in particular and as an organic whole.

If the Crowdfunding Module were to employ multiple levels, IP participation in them could be limited to achievement qualification(s). One example would relate to recruiting and personal sponsoring of other individuals to participate in the RCF Module and/or other Modules.

This brings us to a potential and significant Coding problem for the RCF system. In one form, the RCF system accepts IR sign-ups on a “first come, first serve” basis, indiscriminately. This (optional) indiscriminate method is for the purpose of overcoming the “average person’s” inability to sponsor other individuals because they lack sales ability or for other reasons. The minimum sponsoring for a matrix or binary is two recruits, and if a matrix or binary is a consecutive and coincident Module, the IP necessarily needs to personally sponsor two people. This is accomplished as shown in FIG. 4A, as items 25, 26, ((1) Single Pass-through, Single Sponsoring) “AS/C” (Auto-Sponsored and Coded person), requiring two separate Coding’s via the initial participant entry and second subsequent re-entry, or as shown in FIG. 4B, as items 32, 33, ((2) Single Pass-through, Double Sponsoring) “AS/C” via the initial participant entry. Since the RCF system in one form accepts IR sign-ups on a “first come, first serve” basis, indiscriminately, if an IP enters into the RCF system and then afterwards intends to sponsor another individual to the IP “qualifications earning benefit”, there must be a method to accomplish this, as well as additionally benefit the IP.

One method of Coding a new recruit into the RCF Module is accomplished by means of the IP providing the intended new recruit with a form of participant number or code, which the RCF system automatically provides any new participant IP with. This number, code, or designator, would be unique to each participant IP in the RCF system, and thus following them, coding them, throughout all the Modules of the entire (Eco) System. This Code would also allow for and provide the (Eco) System with the ability to track and monitor all participant behavior and that of their personally sponsored individuals as well as their entire downlines in the case of outside Network Marketing usage. The number, code, or designator is, therefore in such a case, an indispensable aspect of RCF, which typical Crowdfunding does not utilize or employ, thereby making the RCF system set apart from traditional Crowdfunding for an additional reason apart from the reciprocation aspect. The RCF platform would, therefore, require the ability to receive an “authentication code”, which the new recruit would be able to enter the IP’s personal identifier code into, an identifier methodology that most MLM companies employ.

Another significant situation foreseeably encountered by the RCF system in relation to established Social Network Marketing or MLM usage is the ability to accept and code a new IP who has previously built up an entire downline in another Multi-level Marketing company(ies) and wants to bring that entire downline with them into the RCF, retaining the sponsoring connections of their downline from the other MLM company(ies). This can be achieved through the coding methodology described in this “SPONSORING”, “CODING”, “QUALIFYING” section, and additionally by providing a separate portal or sign-in area aspect of the RCF platform, specific to leaders of other MLM’s, for the purpose of retaining and connecting their downlines to them in this modular (Eco) System. Additionally, Coding can be automatically accomplished by the individual first entering into any various Module and thereafter the RCF Module indiscriminately.

If the RCF is designed to provide for higher-level achievement, with larger pay-outs to benefit those who qualify by sponsoring more people into the system, it will also require the RCF to be programmed to delineate between the indiscriminate Auto-Coding, and IR/IP specific Coding. It must also be noted that the RCF Module in itself requires no Coding of persons passing through it, since it is an entirely linear, indiscriminate progression. The Coding therefore more specifically relates to the other primary Modules as shown in FIG. 2, Modules b, d, e, f, g, h, and sub-Modules such as items 7 thru 14, etc., along with any other Modules the (Eco) System as a whole would potentially employ.

Although the Crowdfunding Module can and does act as a stand-alone commodity, it has a substantial purpose in the self-contained (Eco) system, in that it provides hyper-stimulus to hyper-populating the (Eco) system, acting as an enticing portal or doorway into any given subsequent Module. It enables a financed entry into subsequent Modules to occur without any direct out-of-pocket expense, which is a significant improvement and advantage over typical, traditional MLM and Social Network Marketing methods.

The primary uniqueness and attractiveness of this reciprocating Crowdfunding Model is the low cost/expense (gift/donation) entry point, as well as its unique reciprocal aspect, which makes it appeal to the widest and greatest possible successful reception.

### RCF Platform Self-Perpetuation

A primary functionality and feature of the “RCF” Module System is its inherent ability to be self-perpetuating, a function which guarantees the “feeding” of the other Modules by this primary Module. By “feeding” is meant the population of the other Modules of people and monetary resources to benefit those persons, either directly or indirectly, via the Binary, Trinary, or Matrix algorithms.

To accomplish this feat, the RCF Module dynamics of the aforesaid auto-re-entry must be accomplished in such a manner as to firstly prevent individuals from entering back into the system too fast so as to preclude new-comers or those who enter into the System after the Campaign Initiator (“CI”) from entering the RCF Module before the CI to benefit from the CI coming in sequentially behind them and financing their Campaign, thus also providing the System with the inherent ability to Self-Perpetuate, as well as regulate the amount of money “gifted” to any single individual CI.

A provision is made, as shown in FIG. 3B, 28a, of an example $3,810 “Re-Entry Fee”. This monetary withholding is to assure that the system can reimburse participants in the event of a complete system collapse or in the unlikely event that the system for any given reason doesn’t continue to populate after a last or final CI enters the system. This provision additionally prevents the system from being considered a Ponzi scheme. Should the system never need to reimburse participants due to a statistically assured propagation integrity, the monetary withholding could then be used in other ways to benefit the system and system participants.

### RCF Platform Cycle Mechanics

For example purposes, the System’s ability to Self-Regulate and Self-Perpetuate can be accomplished by the CI having “cycled”, now having to wait a certain and engineered period of time before re-entry, to assure that they do not “plug-up” or over-advantage themselves of the System, preventing others from entry or re-entry and ability to “cycle”. In other words, in this scenario, there is no instantaneous re-entry into the RCF Module once the CI exits upon “cycling”. The CI may have to wait multiple “cycles” after it’s “cycle” exit for the RCF Module itself to “cycle” those CIs who were in the RCF Module at the same time, behind the subject CI, and the exact same number following into the RCF Module, before the subject Cl is auto-re-entered into the RCF Module, and so on.

Additionally, an example can be made that each time the subject CI exits the RCF Module as a “cycle”, the System must wait the same number of “cycles” the subject CI “cycles” before auto-re-entering the subject Cl. For example, after the subject CI exits the RCF as “cycle” one, its first “cycle”, it must wait two “cycles” before being auto-re-entered into the RCF Module, and upon that second auto-re-entry “cycle”, must wait three subsequent System “cycles” before being auto-re-entered. Then after the CI’s third “cycle”, must wait four System “cycles” before being auto-re-entered, and so on. Conceivably then, the subject Cl could have to wait an eventual significant amount of time or “cycles” before it can be auto-re-entered, thus limiting the amount of “cycles” any given CI can experience in any given period of time, which would conceivably provide a mechanism for a more equitable System distribution of CIs and “donation” capital throughout the System, thereby assisting in the self-perpetuating aspect of the RCF System in particular, and the “Eco” System as synergistic a whole.

Argument can be made that as a matter of fairness and equity, the System would and should prevent the subject CI from auto-re-entry before the very last Cl to enter, thus entering “behind” the very last Cl and helping to finance the System and previous CIs rather than continually being able to benefit from continually “cycling” before other CI’s have had an opportunity to “cycle” and gain from the System. This however is neither possible nor practical. There may be no conceivable way to know when the “very last” person as a CI enters or re-enters the RCF System, since there could conceivably be upwards of a billion or more people world-wide entering or re-entering the RCF System at any given time. Therefore, there may always be some form of inequality of “donation” distribution relating to auto-re-entry, no matter how the auto-re-entry is regulated and accomplished. One possible way to remedy this would be to wait 24 to 48 hours, or longer, for a week or even a month for any “donation” distribution to occur, until the System can calculate the number of CIs who have processed through the RCF Module System before “balancing” out the “donation” amounts to each and every CI within that period of time, so as to provide a fairer and more balanced outcome for all concerned. Another method would be to simply limit the amount of “donation” money any given Cl can experience within any various period of time, thereby simplifying the equity and output quotient. Additionally, other remedies applied.

### System Pay-Out or Monetary Distribution Mechanics

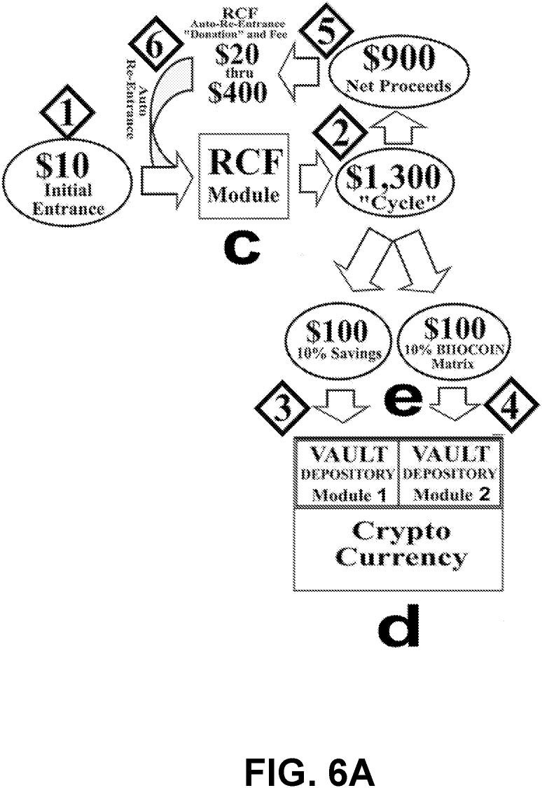

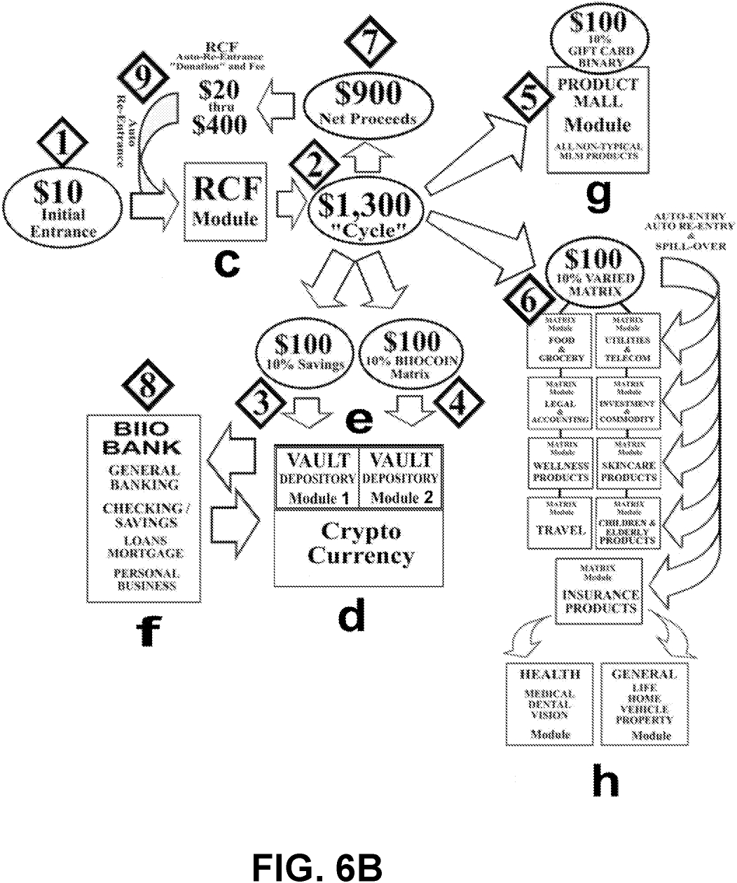

To understand the sequence of System events, the paragraph numbers below correspond to the numbers in the number diamonds throughout the FIGS. 6A & 6B diagrams. The “You”, “you” or “your”, refers to the “YOU” of FIGS. s 3A and 3B.

1) To begin, after You sign up, you, as a new Cl, contribute, gift, or donate an initial donation, in this case $10, and the System does virtually everything else for you and other subsequent CIs - in fact, neither you nor the other subsequent Cis would ever have to experience another out-of-pocket expense. The CIs only real involvement is when it comes to the CI choosing whatever products the CI wants to receive. You, the CI, easily specify those and can change them so that you and other CIs don’t get over-saturated with any one product or service.

2) Secondly, as other CIs initiate campaigns and enter the RCF Module behind you, propelling you through, you complete the Module, which is called a “Cycle”. In the FIG. 6A case depicted, your Gross Proceeds are $1,300.

3) Thirdly, in the case shown, the System automatically saves 10% of your money for you in the DEPOSITORY by purchasing $100 of Cryptocurrency, through or apart from a matrix system. This will continue to increase in value for you. It’s part of your (early) retirement and lifestyle enabler.

4) Fourth, in the case shown, the System automatically applies 10% of your money for you in the VAULT DEPOSITORY Matrix. This Cryptocurrency investment purchase produces an additional income stream because it’s set up as a Matrix which has a (sizable) monthly pay-out. Another advantage is that you will be saving an additional $50 in the VAULT DEPOSITORY. Yet another significant advantage is that you will be able to leverage your savings in the VAULT DEPOSITORY via the BANK as collateral for loans for such things as boats, cars, homes, etc.. (The “collateral” factor ensures that the Cryptocurrency Value stays intact, stable and strong.)

5) Fifth, the System automatically applies 10% of your money for you for an Amazon, Walmart, eBay, or other Commerce Gift Card. The purchase produces yet another additional income stream because in this embodiment it is based on a Binary System, similar to the Matrix, but you can “Cycle” more often than monthly, even daily. Every time you “Cycle”, you continually get more valuable Gift Cards and more Money. The reason for utilizing Gift Cards is because they are easy to use and cost effective to ship; QR Codes or simple internal system “credits” can be used in their advent, and this methodology provides many options and benefits besides a simple purchase. The system internally can provide its own Gift Card, useful anywhere within the Eco Commerce System, generating even more money for supporting the System.

6) Sixth, the System automatically manages 10% of your money for “You” for a purchase of whatever product(s) you want to receive once a month through a series of Matrix’ that you will yet again make money from every month — from every Matrix — and you qualify for that money simply by making a product purchase in each matrixed Module.

7) Seventh, after the preceding process takes place you end up with a sizable Net Proceeds, in this particular case, of $900 for your initial $10 Campaign Gift.

8) Eighth, in this example, an automatic deposit of the $900 is made in the BANK for you. Here you have your Checking and Savings accounts, your Debit Card, and everything else that online banking provides you with. The difference in this case is that you are linked to the VAULT DEPOSITORY.

9) The next step is to Auto-Re-Enter the (RCF) Module and start the entire process over again, in a continuous, repetitive cycle, in order to perpetually advantage from the system.

### Product Mall

In the diagrammatic flowchart shown in FIG. 2, item h, can relate to an existing Retail, Service, MLM or Social Network Marketing company and its products, showing how such an existing company can be integrated into the organic “Flow” system or how such an existing company can integrate the system unto itself. FIG. 2, h, can also relate integrally to the system itself apart from any existing MLM or Social Network Marketing company. The FIG. 2, item h Module and sub-Modules are also optional to the system and do not need to be employed.

The diagrammatic flowchart shown in FIG. 2, item g, relates to a “Product Mall”, which provides a single access point portal to a single or multiple outside retail products distributing business such as for example, Amazon.com, Walmart, or any other retail product distribution entities. The same Multi-level Marketing or Social Network Marketing principle of a monthly financial commitment could still apply since the matrix application would be used in any event, with purchase percentages distributed throughout through any varied means. In differentiation to MLM or Network Marketing, the individual System Participant (SP) can agree to a fixed monetary amount purchase or simply “store-up” credits to a larger purchase at a later date past the monthly monetary contribution into the FIG. 2, items g and h, Module system.

### App Mall

Additionally, whereas most present “App and Product Malls”, such as the well-known Apple “Mall of America”, are set up to solely offer the buying or selling of Apps and products, the Invention (Eco) System “Product Mall” is a “Mall” to access and use all other Apps including but not limited to social media such as Facebook, Twitter, and others, myriad general Apps, search engine apps such as but not limited to Google, retail apps such as but not limited to Amazon.com, entertainment apps such as but not limited to YouTube, and myriad apps in general, with the intention and design, to provide Incentivized usage and sharing, to provide a monetize the usage of them through a monthly matrix type fee for the benefit of the (Eco) System participants.

The purpose of monetizing the usage of so-called “free” internet services such as social media, Google, YouTube, etc., is in seeking to reverse the problem with “free” internet services. It is well known that the main social media and other “free” internet services monetize their users; their users become the “product”. The Invention seeks to make the “free” internet services the product, and the users the monetary beneficiaries by utilizing said services. The purpose for this is a matter of wealth creation and distribution, which is more inclusive and equitable for the masses of humanity, and which intentionally and purposefully flows directly from the participants to the participants. This is not to exclude the ability to monetize the participants as the said internet services do, but an effort to direct that monetization back into the (Eco) System to benefit the entirety of the (Eco) System participants, including corporations within and without the system.

The secondary intention of the Invention App Mall’s arrangement is the App’s ability to track, quantify, and gather consumer information on spending and usage habits throughout its own membership organization to benefit the individuals and organization as a whole.

A further purpose of the Invention App Mall’s arrangement is the App’s ability to provide a “Facebook” “Twitter” type, “Members Only” communications platform, as shown in FIG. 1, item b, where varying degrees of communication capability is provided based on “qualification/achievement” and “need”, as well as in general usage. An example of this would be a Multi-level Marketing high-level leader with an extensive downline having different access and privileges for the communication’s platform use and postings than lesser qualifying individuals in the downline. Messages by “leaders” can be limited by them to their own specific downlines. In one form of the invention, their messages can also be marked as confidential and therefore un-shareable to anyone outside the particular downline or “unqualified” individuals within the downline. Leaders’ messages can also be marked as “Global” and therefore readable and sharable openly throughout the (Eco) System and beyond the limit of their specific downline. A myriad of other services can be provided through this communications network well beyond the purpose and scope of personal interactions, such as advertising of the (Eco) Systems products and services, and also other products and services that can be outside the (Eco) System itself.

### Vault Depository Savings and Wealth Generation System

In the FIG. 1 (Eco) System diagrammatic flowchart shown in FIG. 1, item e, relates to a monetary or Cryptocurrency “Depository”. The “Depository” is a single Module with a dual purpose, the “Saving” side, and the “Monetizing” side, although only the monetizing side is necessary. The “Depository” utilizes the reciprocating Crowdfunding model adapted for the purpose, or MLM model monthly purchase obligation and seeking to attain the similar Crowdfunding and/or MLM results of monetary generation, distribution and re-distribution. In this particular scenario, the Depository is accessed through prior involvement in the FIG. 1 flowchart system, specifically through the FIG. 1, item c, RCF Platform.

The Depository is a means whereby a participant can save money by having an in-system-specific Cryptocurrency deposited, i.e., a Cryptocurrency specific to and developed exclusively for the system shown as item d, in FIG. 1. The reason for utilizing an in-system-specific Cryptocurrency is to eliminate problems generally associated with Cryptocurrencies while advantaging by Blockchain technology.

A further reason to utilize a “Depository” is for the accumulation and compounding of System wealth to the benefit of all System Participants, (SPs). As the cryptocurrency is continually purchased and re-purchased every “Cycle” by SPs, the value of the cryptocurrency, in known manner, continually increases.

The (Eco) System utilizes Cryptocurrency and Blockchain technologies to enhance and/or provide retirement savings through an Incentivized Sharing Depository that generates “interest” in the form of accumulating cryptocurrency cost and value as the in-system Cryptocurrency amount increases via mass involvement and contribution into the system by myriad system participants, through the automatic entry and re-entry (purchase, re-purchase) methodology.

Blockchain is the technology that enables the existence of cryptocurrency, among other utilizations. A cryptocurrency is a type of “digital money” or currency that uses highly encrypted digital files as money that can be used to buy goods or services. It is a medium of exchange, such as the US dollar, but is entirely digital and uses encryption techniques to control the creation of monetary units and verify the transfer of funds.

Again, the reason for utilizing an in-system-specific cryptocurrency is to eliminate problems generally associated with cryptocurrencies, such as to eliminate or significantly reduce value manipulation by outside forces that results in losses and volatility, and create monetary stability. Another reason to utilize an in-system-specific cryptocurrency is to “flatten the curve” of foreseeable multiple world currencies being utilized to purchase into the Depository. Yet a further reason to utilize a cryptocurrency, whether internal or external to the system, is as a means to allow System participants to make money off the purchase of it as a Commerce Commodity through a Matrix algorithm similar to that which is used by Multi-level and Social Network Marketing.

The FIGS. s 1 and 2 platform in the aggregate seeks to provide stability and utility to a generally unstable and consequently a considerably constricted use, mainstream cryptocurrency system, most specifically as it relates to a thoroughly accepted and commercialized exchange for goods and services. The main problems the system seeks to overcome with mainstream cryptocurrencies are as follows:
1. By far, the biggest issue in the cryptocurrency market is the excessive volatility, along with price manipulation. The prices of cryptocurrencies on exchange platforms rise and fall dramatically over a short period of time. When a tradable asset can drop by as much as 49 percent in less than 24 hours, then the volatility of the market is high.
2. As of May 2021, more than 2,000 cryptocurrencies failed.
3. A major problem in the cryptocurrency market is the lack of innovation by developers.
4. Scalability. Probably the biggest concerns with cryptocurrencies are the problems with scaling.
5. Hacking problem.
6. Lack of regulations.

The Invention’s solutions to the foregoing problems are as follows:
1. The FIGS. ′s 1 and 2 platform is a self-contained (Eco) System. Therefore, and thereby, outside influence and price manipulation are entirely eliminated. The Depository cryptocurrency can only be purchased within the self-regulating system. This quality alone has the potential to attract serious investor interest, which can foreseeably and considerably impact and increase the Commerce product sales in all of the above system aspects.
2. The Depository and intersystem cryptocurrency overcome the potential problem of cryptocurrency failure due to it being a self-contained currency within a self-contained platform and (Eco) system.
3. The Depository and intersystem cryptocurrency overcome the lack of innovation by developers due to the entirely unique platform it operates on and how and why it operates.
4. The Depository and intersystem cryptocurrency overcome the scalability problem due to the entirely unique platform, how and why it operates, and it being a self-contained currency within a self-contained platform and (Eco) System.
5. The Depository and intersystem cryptocurrency virtually eliminate the hacking problem because it is not “public”, is akin to stablecoin but enabling stability in an entirely unique manner, and securely contained within, and useful only within the (Eco) System operating platform, thereby giving little to no incentive for hackers to attempt to profit by hacking. This does not mean to totally limit the usage of the intersystem cryptocurrency entirely within the (Eco) system, as there are means of providing stability if the usage is in part exosystemic.
6. The Depository and intersystem cryptocurrency overcome the lack of regulations problem, again, due to the unique platform it operates on, and how and why it operates, and it being a self-contained currency within a self-contained platform and (Eco) system. The VAULT Depository platform provides rules and regulations for the cryptocurrency distribution, its retention within the Depository, its extraction, its predominant usage within the (Eco) system, and its conversion to other forms of currency to ensure stability and perpetual increase of value, the primary nucleus for its usage being in one manner a form of retirement security; a store and compounding advancement of residual income type based wealth.

### Banking

The Banking system shown in FIG. 1, item f, works principally in tandem with the VAULT Depository system shown in FIG. 1, item e for the primary purpose of converting and enabling funds placed in the Depository to be later utilized by the system participant depositors within, throughout, and potentially outside of the (Eco) system, in various world currencies if necessary.

One purpose for an internalized Banking system is to provide readily attainable loans against Depository accounts that would thereby be collateralized loans. The reason for this collateralization is in an effort to maintain as much Cryptocurrency money in the Depository as possible at all times for the purpose of increasing wealth for all participating in the Depository retirement and wealth generating/saving system. If too much Cryptocurrency were removed at any given time or over any length of time, the value of the system Cryptocurrency would diminish. To prevent any serious diminishing of the Cryptocurrency value as would involve significant withdrawals relating to potentially large purchases such as homes, properties, jewelry, boats, etc., especially if a great many individuals wanted to make large withdrawals at the same time, the safeguard to maintaining the Cryptocurrency value would be accomplished through collateralized loans. And although this could be accomplished through banking means outside of the (Eco) System, the preferred method would be an internalized banking means, as a method of providing for a more system specific process of management and control for assuring systemic continuity, stability, and security.

An internal Banking system can additionally and more readily provide mortgage and other loans utilizing Depository funds as collateral, further providing that the (Eco) system is self-contained and regulated, and therefore not subject to outside manipulating forces that could potentially adversely affect and degenerate the (Eco) system in part or in whole. An internal Banking system would further ensure that wholistic continuity is maintained throughout the entire (Eco) system, enabling participants to more readily and easily utilize various system aspects to their advantage, more synergistically and holistically.

The societal need for the Banking system shown in FIG. 1, item f, and the VAULT Depository system shown in FIG. 1, item e, become all the more apparent when considering the primary need and challenge faced by societies in general, which is the common inability of people to obtain low interest to no interest loans; to earn sufficient money; to save sufficient money for retirement and other matters; and most specially to provide for their future and retirement needs.

In addition to the afore described typical functions of a Bank and Depository, both the Bank and Depository Modules described here function as a form of residual income mechanism, monetizing these formerly and historically non-monetized Banking and Depository Savings functionalities, through either a Binary, Trinary, Matrix, or other such algorithmic mechanism.

The (Eco) System in part and in whole shown in FIG. 1 seeks to resolve and solve a nagging problem, that being, gently and organically taking the pressure off governments and often poorly run company pension plans to solely provide for retirement and other benefits needs. In the case of the United States, according to Google search, 2034 is the year in which the Social Security Administration estimates that it will largely become insolvent. This virtually guarantees that taxes on wages and otherwise will be raised and benefits will be lowered, putting significant downward pressure on entire generations within and outside of the system. Additionally, many companies have eliminated their pension plans entirely, forcing the working class to fend for themselves, often poorly and misguidedly. These substantial issues can be easily resolved with a relatively simple and organic system that addresses the basic needs of the average person, such as the system being disclosed herein.

In the Module application shown throughout the system, a new and innovative methodology is proposed that utilizes Gift Cards, and/or, Tokens, and/or simple System Credits, and/or (as known) “QR” (Quick Response) Codes as the internal “gift - donation”, or external Multi-level MLM or Social Network Marketing retail distribution product. A gift card is a well-known retail commodity. It can be easily used as a marketing tool for MLM recruitment. A QR code works in the same way as a barcode at the supermarket. It is a machine-scannable image that can instantly be read using a Smartphone camera. When a Smartphone scans this code, it translates that information into something that can be easily understood by computerized retail systems and converted to human understanding. QR codes can be sold and transferred to MLM recipients more readily and cost-effectively than Gift cards and utilized more efficiently at point of purchase for the consumer. The QR codes can optionally be chosen by the purchasing recipient in lieu of Gift cards to minimize oversaturation of Gift cards in the recurring binary pay-out/repurchase “cycle”. This option is due to some MLM Distributors “cycling” so often during a week that the number of repurchase Gift cards can become over burdensome. Another means of solving this problem is a rechargeable Gift card, or the IR choosing multiple types of Gift cards to “cycle” through.

Government legal requirements on Multi-level marketing methods may necessitate the SPs purchase of a physical product, in which case Gift cards are the preferred method of transaction, but immediately thereafter could be internally traded for “credit(s)” and could thereby novelly, and potentially legally and otherwise eliminate the need for the actual physical sending or delivery of the Gift card to a system participant.

In the (Eco) System diagrammatic flowchart shown in FIG. 1, item a, the system also provides a comprehensive information database relating to all the foregoing business model systems. In another aspect, the system connects users with other users and professional and/or product-based services based on the users’ activities and industries. In another aspect, the system allows and provides for the spending of the cryptocurrency within the self-contained and self-regulated (Eco) System.

The System’s FIG. 2, items g and h, monetizing and money generating “Modules” can relate to various commerce or service providers, such as are used in known manner in typical mainstream Multi-level Marketing and Network Marketing. These include, but are not limited to, utilities, food, clothing, health and wellness related products, pet products, insurance of various kinds, prepaid legal services, cryptocurrency, commodities such as gold and silver, and lottery and sweepstakes related offerings to name but a few. In the case of the Invention, all of the above and more are to be considered within the scope of the invention’s capability and intent.

### System Delivery Mechanism and Humanitarian Aid

Due to the System being self-contained, and money, products and services are provided directly to the SPs, waste of resources is additionally eliminated, which makes the delivery mechanism ideal for Humanitarian Aid utilization. The System is deliberately engineered to overcome the systemic problem of people not receiving the quantity or quality of humanitarian aid provided and delivered by various governments and agencies to other governments and their agencies for distribution to their poor and needy populations.

Firstly, the System is fully autonomous, so there is minimal if any chance for corruption from inside or outside the System.

Secondly, and most importantly, the System delivers the money, goods and services directly to the people (SPs), solving the problem of money, goods and services going mysteriously missing, or not getting to the people (SPs) due to corrupt governments and agencies pilfering or limiting the deliveries. Prior to this innovation, past and present inefficient and corrupt systems deliver the money and other things to the people indirectly, opening the door to vast levels of corruption and even criminal activity, which problems the invention proposes to solve.

Thirdly, because the System described delivers directly to each individual person (SP), the added positive consequence is limited to zero waste, not just bypassing corruption, but bypassing waste.

Fourthly, because the Monetary System as described is internal to the System, and can largely or only be spent within the System, near perfect security is achieve, unlike distributing the money to Governments, in the hope that they will distribute it to the people instead of feeding their military and only their political supporters with it.

### System Fees From Outside Agencies

Due to the System being self-contained, there are various means to provide for monetary supply and resupply in order to achieve optimum System integrity. As previously described, the Auto Re-Entry is chief among these methods. However, for goods and services to be brought into the System from outside the System, the only three options are:

1). Outside corporations and businesses may belong to, and function integrally within the System as in a Membership, which would require from them that any money generated by the System be kept largely or entirely within the System by these outside agencies, corporations and businesses, requiring minimal System fees; and/or,

2). Outside corporations and businesses could participate in the System to sell their goods and services by paying higher System Fee(s), which would regulate and balance out the give and take, to and from the System, with the specific engineered intention to maintain and prosper the System’s economic strength and integrity; and/or,

3). Goods and Services are provided by and from the System itself, via Corporations and businesses which are System owned and operated, with all proceeds to such being largely or solely contained and kept within the System, with the express intention to maintain and prosper the System’s economic strength and integrity. Profits from said Corporations and Businesses would be paid in System currency and kept within the System, all spending, banking, and saving being advantaged by the System’s Matrixed Banking and Saving System(s), as previously described, further benefiting and enriching the System as an organic whole.

Outside monetary supply and re-supply may or may not be necessary to ensure the perpetualized functioning of the System. However, this inclusion is a highly likely outcome of the broad nature and functioning of the System if employed on a global scale, and therefore has necessarily been taken into the invention’s consideration and claims.

### Universal Basic Income

The near entirety of government, and otherwise proposed Universal Basic Income (UBI) Systems, have as their monetary capitalization basis the use of taxation, excise, and other assessment collected money as the sole to near-sole source of income from which to then redistribute amongst the population at large. This arguably can cause significant financial burden to people and businesses, along with considerable dislocations and distortions in the balance and synergy of industries and economic activity on myriad levels.

The invention, therefore, further intends to provide a workable means to achieve monetary generation, re-generation, distribution, and redistribution of capital, goods, and services amongst the population at large without taxation, as shown in FIG. 1, items a thru h, and FIG. 2, items b thru h. The methodology disclosed provides an organic, synergistic, and self-perpetuating mechanism to achieve a UBI System which not only unburdens governments of the need to excessively tax, or administrate, but also provides safeguards to the distribution and redistribution of wealth as previously stated, while encouraging and even compelling economic growth to the benefit of businesses, the country, and its population. The System as described, in whole or in part, could effectively resolve insolvency issues that governments and businesses admittedly have, and expect to have, with regards to entitlement, welfare, benefits, and pension programs.

What is claimed is:

1. A method for crowdfunding comprising the steps of:
generating money, goods or services, individually or in various combinations, through a dynamic methodology comprised of reciprocal donation or gifting transactions between donators and donatees;
acquiring money, goods, or services, individually or in various combinations, through reciprocal donation or gifting transactions between donators and donatees;
distributing money, goods or services, individually or in various combinations, comprised of and accomplished through a matrix, binary, trinary, unilevel, or other such Network Marketing or Multi-level Marketing type compensation plan structure and associated algorithm(s).

2. A method for a Universal Basic Income (UBI) system comprising the steps of:
generating money, goods or services, individually or in various combinations, through a dynamic methodology comprised of reciprocal donation or gifting transactions between donators and donatees;
acquiring money, goods, or services, individually or in various combinations, through reciprocal donation or gifting transactions between donators and donatees;
distributing money, goods or services, individually or in various combinations, comprised of and accomplished through a matrix, binary, trinary, unilevel, or other such Network Marketing or Multi-level Marketing type compensation plan structure and associated algorithm(s).

3. The method of claim 1, comprising a process of autonomous money generation used to eliminate the need for Independent Representatives associated with Network Marketing, Multi-level Marketing, or residual income type systems being required to market products or services, sell to, or recruit, other Independent Representatives to qualify for monetary or other earnings or rewards.

4. The method of claim 1, wherein Crowdfunding is comprised of and utilized for the purpose of:
enhancing and monetarily capitalizing a Universal Basic Income system; and/or,
enhancing and monetarily capitalizing social media type system platforms; and/or,
enhancing and monetarily capitalizing commerce systems; and/or,
enhancing and monetarily capitalizing Network Marketing or Multi-level Marketing systems; and/or,
enhancing and monetarily capitalizing Affiliate Marketing systems; and/or,
enhancing and monetarily capitalizing a cryptocurrency, token, smart contract, or other DeFi type system(s); and/or,
enhancing and monetarily capitalizing Banking and Savings and Loans type financial systems; and/or,
enhancing and monetarily capitalizing lottery, sweepstakes, gaming, or casino type systems; and/or,
enhancing and monetarily capitalizing App Mall type systems;
with or without the above said system(s) being utilized independently or dependently upon a matrix, binary, trinary, unilevel, or other Network Marketing, Multi-level Marketing, or Affiliate Marketing type system methodology.

5. The method of claim 1 comprised of an Auto-Sponsoring and Coding system.

6. The method of claims 1 or 2 comprised of a commerce and/or services (Mall) platform capable of being operated independent of or dependent upon being incentivized through the claim 1 methodology.

7. The method of claim 2 comprised of a Social Media type communication platform capable of being operated independent of or dependent upon being incentivized through the claim 1 methodology.

8. The method of claims 1 or 2 comprising a system wherein the participants are code-able to specific qualification achievements, individuals, groups, or Network Marketing or MLM existing uplines or downlines.

9. The method of claims 1 or 2 comprising a residual income-based Cryptocurrency, Stablecoin, Token, Smart Contract, or other such DeFi type platform(s), independent of or dependent upon being incentivized through the claim 1 methodology.

10. The method of claims 1 or 2 comprising a Savings or Depository type platform, said platform being capable of being operated independent of or dependent upon being incentivized through the claim 1 methodology.

11. The method of claims 1 or 2 comprised of algorithms and other mechanics to enable and encourage Incentivized Sharing of an individual platform or series of coincident platforms with the intent purpose to self-monetize the participant users.

12. The method of claim 1, comprising a Universal Basic Income System or otherwise residual income type system used for commerce, banking and finance purposes and the marketing of products and services.

13. The method of claim 1, which utilizes Gift cards, “QR” codes, or “Tokens”, or “System Credits”, as a means of:
(a) enabling system participants to divest themselves of excess product by donating it and/or the purchase price into an intermediary mechanism that provides for other individuals within the system or “orphans” and others in MLM downlines to receive product through a lottery, sweepstakes, or other “give-away” methodology.
(b) enabling system participants to divest themselves of excess product by donating it and/or the purchase price into an intermediary mechanism which provides charitable organizations with specific and quantifiable assistance financially, or in the form of gift cards.

14. The method of claims 1 or 2 comprising the utilization of a form of Bank, coincident or not with a savings depository, that employs blockchain and cryptocurrency, and other FinTech technologies by which to complement and assist in the functionality of the system, independent of or dependent upon being incentivized through the claim 1 methodology.

15. The method of claim 3 comprising the distinction that it can alternately be based entirely upon the claim 1 Reciprocating Crowdfunding Model, where, in lieu of products or services being purchased by and for the individual, they are purchased as a gift for other individuals within the System, and as such, departing entirely from the standard Network Marketing and Multi-level Marketing models of purchase performance; embodying and enjoying the entire nature of Crowdfunding gifting and donating, obtaining all of the known benefits of Crowdfunding and donation based giving.

16. The method of claims 1, 2 or 3, comprising a system which may or may not require participants to qualify for varied levels of achievement to attain monetary, product, or services gain in the form of reward, gift, donation, or payment.
